(19) United States
(12) Patent Application Publication
(10) Pub. No.: US 2026/0203835 A1
(43) Pub. Date: Jul. 16, 2026

(54) ASSISTED TAX PREPARATION USING AN ARTIFICIALLY INTELLIGENT ASSISTANT

(71) Applicant: HRB Innovations, Inc., Wilmington, DE (US)

(72) Inventors: Vinayak Kamat, Cypress, TX (US); Adit Agarwal, Champaign, IL (US); Victoria Ward, Kansas City, MO (US); Steve Danzo, Gravois Mills, MO (US); Adam Holm, Kansas City, MO (US); Ian Thompson, Kansas City, MO (US); Brian Bustos, Kansas City, MO (US); Aditya Thadani, Arlington, VA (US)

(21) Appl. No.: 19/447,467

(22) Filed: Jan. 13, 2026

Related U.S. Application Data
(60) Provisional application No. 63/745,176, filed on Jan. 14, 2025.

(51) Int. Cl. G06Q 40/12; G10L 15/18; G10L 25/63

(52) U.S. Cl. CPC G06Q 40/123; G10L 15/1822; G10L 25/63

(57) ABSTRACT

Systems, methods, and computer-readable media for constructing a tax return associated with a client during a session. A system may include a historical client data store operable to store historical client data associated with the client. A system may include a session data store operable to store session data associated with the session. A system may include an inferencing agent operable to analyze the historical client data and the session data and generate one or more inferences, the one or more inferences associated with at least one of additional data to gather from the client or a tax data value. A system may include a document manager agent operable to acquire and ingest the additional data from the client into the session data store. A system may include an orchestration agent operable to orchestrate one or more tasks of the inferencing agent and the document manager agent.

### CROSS-REFERENCE TO RELATED APPLICATIONS

This patent application is a non-provisional application claiming priority benefit, with regard to all common subject matter, of U.S. Provisional Patent Application No. 63/745,176 filed January 14, 2025, and entitled “ASSISTED TAX PREPARATION USING AN ARTIFICIAL INTELLIGENCE ASSISTANT.” The above-referenced application is hereby incorporated by reference in its entirety into the present application

### BACKGROUND

### FIELD

Embodiments of the present disclosure relate to tax return construction. More specifically, embodiments of the present disclosure relate to automatic tax return construction using artificial intelligence and information inference.

### RELATED ART

Companies providing tax services often have two competing priorities for their tax return preparation services. One priority is to minimize the time it takes a tax professional to complete a tax return for a client. Another priority is to minimize the time it takes for the client to provide enough information for the tax professional to complete the tax return for the client. Given the paramount need to prepare an accurate tax return, these two priorities are often in tension. For example, many systems designed to save tax professionals time result in more work for the client. Similarly, systems designed to save clients time often result in more work for the tax professional.

Additionally, traditional processes for tax return preparation result in many rounds of asynchronous communication between the tax professional and the client to gather data needed to construct a tax return. Given the time scarcity of the tax season, multiple rounds of asynchronous data gathering and communication may be costly for both the tax professional and the client. As such, systems and methods for automatically constructing a tax return while minimizing the amount of times information is requested from a client are desired.

### SUMMARY

In some aspects, the techniques described herein relate to one or more non-transitory computer-readable media storing computer-executable instructions that, when executed by at least one processor, perform a method for constructing a tax return during a session, the method including: generating, using a machine learning model trained to evaluate historical user data and session data based on a set of tax rules, a first inference indicative of user data to gather from a user associated with the session, the first inference based on the historical user data and the session data; if a first confidence score of the first inference exceeds a first predetermined threshold, prompting the user for the user data; parsing, using a parsing technique, the user data, wherein the user data is parsed from a response received from the user; determining a second inference of a tax data value based at least one of the user data, the historical user data, or the session data; and if a second confidence score of the second inference exceeds a second predetermined threshold, populating a tax field of the tax return associated with the tax data value of the second inference.

In some aspects, the techniques described herein relate to one or more non-transitory computer-readable media, wherein prompting the user includes: generating a natural language query associated with the user data.

In some aspects, the techniques described herein relate to one or more non-transitory computer-readable media, wherein the response is a natural language response to the natural language query.

In some aspects, the techniques described herein relate to one or more non-transitory computer-readable media, wherein the method further includes: in response to receiving the natural language response, performing an emotional analysis on the natural language response to determine an emotional sentiment associated with the natural language response.

In some aspects, the techniques described herein relate to one or more non-transitory computer-readable media, wherein the method further includes: generating, using the emotional sentiment, a second natural language query such that the second natural language query mirrors the emotional sentiment, wherein the natural language query is a first natural language query.

In some aspects, the techniques described herein relate to one or more non-transitory computer-readable media, wherein the user data is parsed from one or more documents received from the user in response to prompting the user, wherein the response includes the one or more documents.

In some aspects, the techniques described herein relate to one or more non-transitory computer-readable media, wherein the parsing technique includes performing natural language processing on auditory input, wherein the response is received as an audio file.

In some aspects, the techniques described herein relate to a method for constructing a tax return during a session, the method including: generating, using a machine learning model trained to evaluate historical user data and session data based on a set of tax rules, a first inference indicative of a document to gather from a user associated with the session, the first inference based on the historical user data and the session data; if a first confidence score of the first inference exceeds a first predetermined threshold, prompting the user for the document; parsing, using one or more parsing techniques, the document, such that user data is obtained; determining a second inference of a tax data value based on at least one of the user data, the historical user data, or the session data; and if a second confidence score of the second inference exceeds a second predetermined threshold, populating a tax field of the tax return associated with the tax data value of the second inference.

In some aspects, the techniques described herein relate to a method, the method further including: verifying, utilizing the user data, that a second tax data value of a second tax field of the tax return is correct, wherein the tax field is a first tax field, and the tax data value is a first tax data value.

In some aspects, the techniques described herein relate to a method, wherein the historical user data includes tax filing information from a previous year, including a filing status of the user.

In some aspects, the techniques described herein relate to a method, wherein the session data includes data obtained from one or more third parties; wherein the method further includes: obtaining, from a third party, the session data, wherein obtaining the session data is initiated by initialization of the session of the tax return.

In some aspects, the techniques described herein relate to a method, wherein the session data obtained from the third party includes a real estate transaction record.

In some aspects, the techniques described herein relate to a method, further including: refining, based on the document received, the machine learning model, such that one or more algorithms of the machine learning model are modified.

In some aspects, the techniques described herein relate to a method, wherein the machine learning model is trained on a set of previous tax returns of the user.

In some aspects, the techniques described herein relate to a system for constructing a tax return during a session, the system including: an inferencing agent operable to generate one or more inferences based on historical user data and session data; a data collection agent operable to generate and transmit one or more natural language prompts to a user associated with the session, the one or more natural language prompts including at least one request for a document; and one or more non-transitory computer-readable media storing computer-executable instructions that, when executed by at least one processor, perform a method for constructing the tax return during the session, the method including: generating, by the inferencing agent using a machine learning model trained to evaluate the historical user data and the session data based on a set of tax rules, a first inference indicative of the document to request from the user, the first inference based on the historical user data and the session data; if a first confidence score of the first inference exceeds a first predetermined threshold, generating, by the data collection agent, a natural language prompt, wherein the natural language prompt includes the at least one request for the document; parsing, using one or more parsing techniques, the document, such that user data is obtained; determining, by the inferencing agent, a second inference of a tax data value based on at least one of the user data, the historical user data, or the session data; and if a second confidence score of the second inference exceeds a second predetermined threshold, populating a tax field of the tax return associated with the tax data value of the second inference.

In some aspects, the techniques described herein relate to a system, wherein the data collection agent is a large language model trained to minimize a number of natural language prompts presented to the user to collect the user data.

In some aspects, the techniques described herein relate to a system, further including: a document manager agent operable to parse the document received by the data collection agent, wherein the document manager agent is further operable to input one or more data fields parsed from the document into one or more tax fields of the tax return.

In some aspects, the techniques described herein relate to a system, further including: an orchestration agent operable to synchronize one or more tasks of the inferencing agent and the data collection agent.

In some aspects, the techniques described herein relate to a system, further including: an orchestration agent operable to suspend one or more tasks being performed by at least one of the inferencing agent of the data collection agent, wherein the orchestration agent is operable to suspend the one or more tasks upon receiving a prompt from the user.

In some aspects, the techniques described herein relate to a system, wherein the orchestration agent is operable to unsuspend the one or more tasks upon transmittal of a response to the prompt to the user.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present disclosure will be apparent from the following detailed description of the embodiments and the accompanying drawing figures.

### BRIEF DESCRIPTION OF THE DRAWING FIGURES

Embodiments of the present disclosure are described in detail below with reference to the attached drawing figures, wherein:

FIG. 1 depicts an exemplary hardware system in accordance with embodiments of the invention;

FIG. 2 depicts an exemplary tax system in accordance with embodiments of the invention;

FIG. 3 depicts an exemplary machine learning system in accordance with embodiments of the invention;

FIG. 4 depicts an exemplary tax assistance client flow in accordance with embodiments of the invention; and

FIG. 5 depicts an exemplary flowchart for illustrating the operation of a method in accordance with embodiments of the invention.

The drawing figures do not limit the present disclosure to the specific embodiments disclosed and described herein. The drawings are not necessarily to scale, emphasis instead being placed upon clearly illustrating the principles of the present disclosure.

### DETAILED DESCRIPTION

The following detailed description references the accompanying drawings that illustrate specific embodiments in which the present disclosure can be practiced. The embodiments are intended to describe aspects of the present disclosure in sufficient detail to enable those skilled in the art to practice the present disclosure. Other embodiments can be utilized and changes can be made without departing from the scope of the present disclosure. The following detailed description is, therefore, not to be taken in a limiting sense. The scope of the present disclosure is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

The following disclosure is broadly directed to systems, methods, and computer-readable media for constructing a tax return for a client. A client may be a business, individual, couple, or any person or company filing a tax return. A tax system for preparing a return, such as that contemplated by the instant disclosure, may include one or more agents, where an agent is a model and/or set of algorithms for completing a set of processes (e.g., a set of tasks). The tasks of the agents of the tax system (and external systems) may be orchestrated by an orchestration agent. The orchestration agent determines transitions to one or more available agents based on the workflow and/or a query of the user. The orchestration agent may initiate tasks by the agents to increase computational efficiency and minimize error.

In some embodiments, an agent of the tax system may be an inferencing agent. The inferencing agent generates one or more inferences regarding the tax scenario of the client. A tax scenario may be the set of information and events affecting the tax return of a client for a given year. For example, the tax scenario of a client may be life events, the client’s income, the home purchase the client made, and the fact that the client got married. The inferences generated by the inferencing agent may have associated tasks. For example, an inference for the value of a tax data field may have a corresponding task of filling out the tax data field. For another example, an inference for additional information needed may have a corresponding action of prompting the client for the information. The inferencing agent may generate a confidence score for each inference, where a confidence score exceeding a predetermined threshold results in the initiation of the task associated with the inference. By generating inferences, the inferencing agent may determine a wider scope of information needed from the client earlier in the tax preparation process. As such, the tax system may prompt the client for information in batches, rather than asking for pieces of information as the preparation process ensues, thereby minimizing the number of times a client is prompted for information.

The tax system may include a data collection agent for prompting the client. The data collection agent may implement natural language processing for communicating with the client and understanding communications from the client. The data collection agent may prompt the client for additional information. Upon receipt of the additional information, a document manager agent may parse the additional information and ingest the additional information into the tax system for use by the inferencing agent.

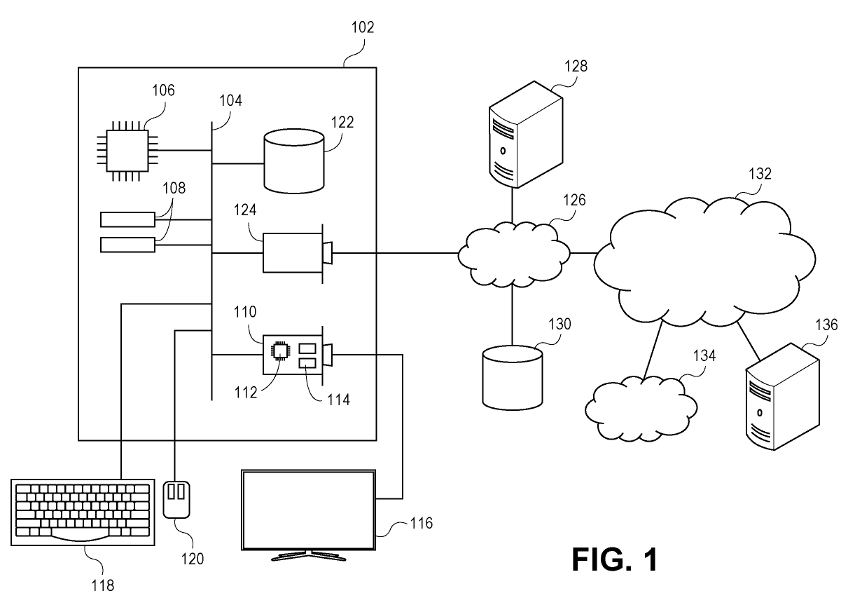

FIG. 1 illustrates an exemplary hardware platform relating to some embodiments of the present disclosure. Computer 102 can be a desktop computer, a laptop computer, a server computer, a mobile device such as a smartphone or tablet, or any other form factor of general- or special-purpose computing device. Depicted with computer 102 are several components, for illustrative purposes. In some embodiments, certain components may be arranged differently or absent. Additional components may also be present. Included in computer 102 is system bus 104, whereby other components of computer 102 can communicate with each other. In certain embodiments, there may be multiple busses or components may communicate with each other directly. Connected to system bus 104 is a central processing unit, referred to herein as CPU 106. Also attached to system bus 104 are one or more random-access memory modules, referred to herein as RAM 108. Also attached to system bus 104 is graphics card 110. In some embodiments, graphics card 110 may not be a physically separate card, but rather may be integrated into the motherboard or the CPU 106. In some embodiments, graphics card 110 has a separate graphics-processing unit (GPU) 112, which can be used for graphics processing or for general purpose computing (GPGPU). Also on graphics card 110 is GPU memory 114. Connected (directly or indirectly) to graphics card 110 is display 116 for user interaction. In some embodiments no display is present, while in others it is integrated into computer 102. Similarly, peripherals such as keyboard 118 and mouse 120 are connected to system bus 104. Like display 116, these peripherals may be integrated into computer 102 or absent. Also connected to system bus 104 is local storage 122, which may be any form of computer-readable media, and may be internally installed in computer 102 or externally and removably attached.

Such non-transitory computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-useable instructions, data structures, program modules, and other data representations. For example, computer-readable media may be non-transitory computer-readable media storing computer-executable instructions that, when executed by at least one processor, perform a method or methods in accordance with the present disclosure.

Finally, a network interface card, referred to herein as NIC 124, is also attached to system bus 104 and allows computer 102 to communicate over a network such as local network 126. NIC 124 can be any form of network interface known in the art, such as Ethernet, ATM, fiber, Bluetooth®, or Wi-Fi (i.e., the IEEE 802.11 family of standards). NIC 124 connects computer 102 to local network 126, which may also include one or more other computers, such as computer 128, and network storage, such as data store 130. Generally, a data store such as data store 130 may be any repository from which information can be stored and retrieved as needed. Examples of data stores include relational or object-oriented databases, spreadsheets, file systems, flat files, directory services such as LDAP and Active Directory, or email storage systems. A data store may be accessible via a complex API (such as, for example, Structured Query Language), a simple API providing only read, write and seek operations, or any level of complexity in between. Some data stores may additionally provide management functions for data sets stored therein such as backup or versioning. Data stores can be local to a single computer such as computer 128, accessible on a local network such as local network 126, or remotely accessible over Internet 132. Local network 126 is in turn connected to Internet 132, which connects many networks such as local network 126, remote network 134 or directly attached computers such as computer 136. In some embodiments, computer 102 can itself be directly connected to Internet 132.

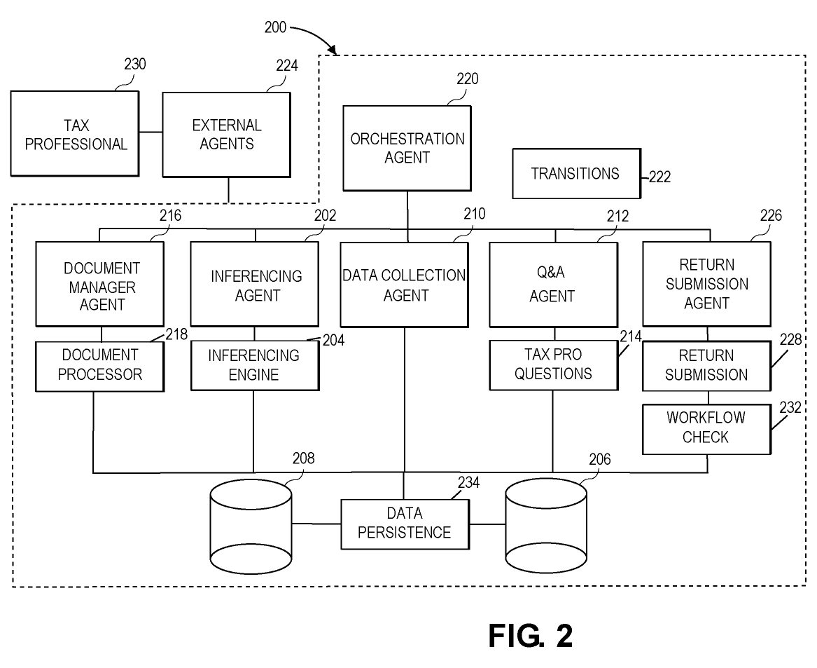

FIG. 2 depicts an exemplary tax assistance system in accordance with embodiments of the invention and generally referred to as tax system 200. Broadly, tax system 200 constructs (or assists in constructing) a tax return for a client during a session based on historically acquired client data and information gathered from the client during the session. Generally, a session is a period in which a tax return is started and completed by tax system 200. In some embodiments, a session is continuous. For example, a session may be the continuous period from starting a tax return filing to finishing a tax return filing. In other embodiments, a session is segmented. For example, a session may include a client interacting with tax system 200 at two distinct time periods for completing a singular tax return filing.

Broadly, tax system 200 utilizes historical data as well as session data to generate inferences regarding the tax scenario of a client and the information needed to construct a complete tax return for the client. Based on one or more inferences, tax system 200 performs the tasks of gathering additional information from the client and constructing a tax return filing. Tax system 200 may minimize the number of times the client is prompted for more information by making inferences regarding the necessary information and tax scenario of the client so as to request all necessary information in the minimum number of prompts.

Broadly, tax system 200 includes a set of autonomous agents for completing a set of tasks performed by one or more plugins, each agent being assigned to one or more individual tasks from the set of tasks. A task may be performed within tax system 200 by one or more plugins, the plugins being processes for completing the task. By assigning separate agents to separate tasks, each agent may be optimized for its tasks, which may result in greater computational efficiency. Additionally, by assigning separate agents to separate tasks, various agents may initiate the performance of tasks at the same time, which may increase computational efficiency.

In some embodiments, tax system 200 includes inferencing agent 202. Inferencing agent 202 may interface with inferencing engine 204, where inferencing engine 204 is a machine learning model trained to analyze a number of data points and make one or more inferences regarding the tax scenario of the client. Accordingly, inferencing engine 204 may be trained to understand and implement a set of tax rules. For example, inferencing engine 204 may be trained to evaluate a data set based on the tax code. Further, inferencing engine 204 may be trained to understand the relationships between various elements of a tax return. For example, inferencing engine 204 may be trained to understand and evaluate the relationship between wages and adjusted gross income (AGI) on a personal tax return. Inferencing engine 204 may implement any type of machine learning now known or later developed including, but not limited to, deep learning linear regression, logistic regression, decision tree, random forest, support vector machine, k-nearest neighbor, Naive Bayes, gradient boosting, artificial neural network, convolutional neural network, recurrent neural network, transformer, generative adversarial network, autoencoder, reinforcement learning model, Bayesian model, Gaussian process, and clustering algorithms like k-means and hierarchical clustering. Additionally, inferencing engine 204 may be trained on any number of training data sets. For example, inferencing engine 204 may be trained on a data set of complete tax returns for a wide variety of tax scenarios. For another example, inferencing engine 204 may be trained on previous filings for a particular client, such as the client of the current session.

Generally, the goal of inferencing agent 202 is to construct a complete tax return for a client, the tax return containing the information needed to complete a tax return filing for the client. As such, inferencing agent 202 may calculate the value of tax data fields within a tax return and fill out the value of tax return fields within the tax return. In some embodiments, inferencing engine 204 calculates and fills out values of the tax return as information is gathered. In other embodiments, inferencing agent 202 stores the inferred value of tax data fields and fills out the tax return after gathering all required information from a client.

In order to complete a tax return for a client, inferencing engine 204 may make one or more inferences. An inference may be a judgment about a piece of data. Inferencing engine 204 may make an inference as to the value of a tax data field. For example, inferencing engine 204 may infer that the value of a text field is “0” based on data available to inferencing engine 204. In some embodiments, inferencing engine 204 is refined as more information is received about the client. For example, inferencing engine 204 may modify the calculus used to make inferences regarding the tax scenario of the client as inferencing agent 202 learns information from the client pointing to a different tax scenario than that currently inferred by inferencing engine 204.

In some embodiments, inferencing engine 204 makes an inference on the tax scenario of the client. For example, if the client filed with the status of married filing jointly last year, inferencing engine 204 may make the inference that the client will be filing with the status of married filing jointly this year. By making inferences on the tax scenario of the client, inferencing engine 204 may determine what information is important to complete the tax return of the client. Accordingly, inferencing engine 204 may determine the important information that inferencing agent 202 does not have. For example, if inferencing engine 204 determines that the home value of the client is important information but inferencing agent 202 has not obtained the home value of the client from historical data or session data (as described below), inferencing engine 204 may determine that the client needs to be prompted for a home value. As such, in some embodiments, inferencing engine 204 makes inferences on the information needed by prompting the client.

Inferencing engine 204 may utilize historical client data and data received during the session to make inferences. Broadly, historical data store 206 may include all historical data related to a particular client that was acquired prior to the current session. For example, historical data may include information obtained in previous tax years, previous tax year filings, profile information, account information, publicly available information that was acquired by tax system 200 prior to the current session, and any other existing data. In some embodiments, inferencing agent 202 may retrieve historical client data from historical data store 206. Historical data store 206 may be any type of data store now known or later developed, including, but not limited to, a local data store, a cloud data store, and an external data store. Historical data store 206 may be maintained by data persistence plugin 234, where data persistence plugin 234 initiates the saving of data within historical data store 206 for later retrieval.

In some embodiments, inferencing agent 202 may retrieve session data from session data store 208 for generating inferences. Session data may include all data gathered from a client or about a client during the session. For example, session data may include information received from the client during prompting. Session data may include data obtained from third parties during the session. For example, session data may include real estate transaction information to determine if a client bought a house. For another example, session data may include public state records to determine if a client was married in the last year. In some embodiments, session data includes relevant tax information, including, but not limited to, information on tax return filing, including tax law, tax code, and the like. Similarly to historical data store 206, session data store 208 may be any data store type now known or later developed. Session data store 208 may be maintained by data persistence plugin 234, where data persistence plugin 234 initiates the saving of data within session data store 208 for later retrieval.

As mentioned above, inferencing engine 204 may use session data and historical client data to determine one or more inferences. For example, inferencing engine 204 may use historical client data to infer that the tax scenario of the client this year is similar to that of the client last year. As such, inferencing engine 204 may use session data to verify the inference of the tax scenario of the client or update the inferred tax scenario based on conflicting information. In some embodiments, inferencing engine 204 may identify conflicting information and infer that verification of a piece of information is necessary. Accordingly, inferencing agent 202 may determine that additional information needs to be requested from the client to verify.

In some embodiments, inferencing engine 204 generates a confidence score for each inference. A confidence score may relate to the certainty of the accuracy of an inference as made by inferencing engine 204. For example, a confidence score of 100 may indicate that inferencing engine 204 knows an inference to be completely factual, while a confidence score of 0 may indicate that inferencing engine 204 knows an inference to be false. Accordingly, the confidence score may be compared to a predetermined threshold to determine whether the tasks associated with the inference are to be implemented. The predetermined threshold may define the level of confidence that inferencing engine 204 is to have in an inference before an action is taken based on the inference. For example, if the confidence score for an inference is below the predetermined threshold, the inference may not be implemented, whereas if the confidence score is above the predetermined threshold, the inference may be implemented. Implementing an inference may refer to initiating the tasks associated with the inference. For example, if an inference states that a particular piece of information is needed from the client, implementing the inference may prompt the client for the piece of information.

In some embodiments, if the confidence score of an inference determines that the inference is not to be implemented, inferencing agent 202 may store the confidence score and inference for potential later implementation. For example, the inference may be stored in session data store 208 for reevaluation by inferencing engine 204 upon the receipt of additional information. In some embodiments, the confidence score associated with an inference and determined by inferencing engine 204 may be updated when subsequent information is received. For example, if additional information is determined to make an inference more or less likely, the confidence score for the inference may be raised or lowered accordingly.

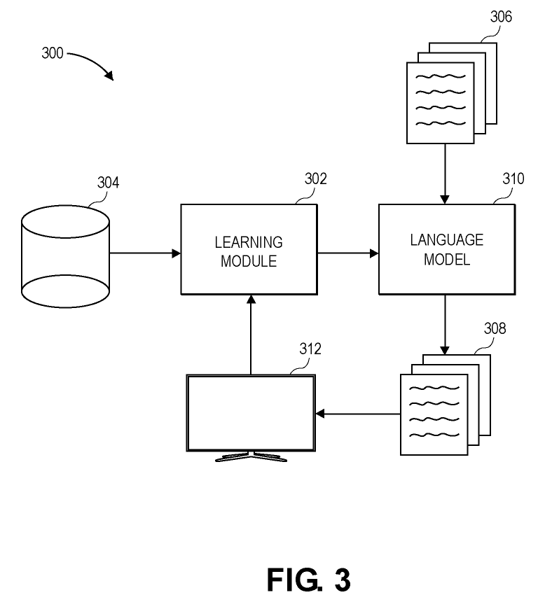

As mentioned above, inferencing agent 202 may implement one or more tasks associated with an inference. Accordingly, in some embodiments, inferencing agent 202 interfaces with data collection agent 210 to gather information about the client when an inference determines the need for additional information. Broadly, data collection agent 210 prompts the client for information. Put another way, data collection agent 210 conducts an interview with the client to gather the information needed to complete the tax return. Data collection agent 210 is discussed more as it relates to language model 310, depicted in FIG. 3.

In some embodiments, data collection agent 210 collects information from the client prior to inferencing agent 202 generating inferences. For example, upon initializing a session, data collection agent 210 may prompt the client for information, and document manager agent 216 (described further below) may process the information (e.g., extracting and classifying data) and begin constructing a tax return based on the information. Accordingly, inferencing agent 202 may then utilize the processed information received from the client to generate a first inference.

As discussed below, data collection agent 210 may be a machine learning model, such as a large data collection agent. Data collection agent 210 may be a conversational bot. In some embodiments, data collection agent 210 interfaces with and/or is trained with the data from historical data store 206 and session data store 208 to generate prompts to the client, said prompts being personalized to the client and the tax scenario of the client.

In some embodiments, data collection agent 210 models emotional intelligence when interacting with the client. Broadly, tax information may be sensitive information such that the client has an emotional response to the tax information. For example, while information on whether an individual is still married to their partner is necessary tax information, the information on marital status may evoke an emotional response in a person if they are recently divorced and/or their spouse is recently deceased. In some embodiments, data collection agent 210 is tailored to the emotional state of the client. In some embodiments, data collection agent 210 mirrors the emotional state of the client. The emotional tailoring of data collection agent 210 is discussed more as it relates to language model 310, depicted in FIG. 3.

Data collection agent 210 may prompt a client to input and/or upload information. For example, data collection agent 210 may prompt a client to upload W-2 forms. For another example, data collection agent 210 may prompt a client to input his or her date of birth and Social Security number. In some embodiments, data collection agent 210 prompts a client using natural human language. For example, data collection agent 210 may output a written sentence reciting, “Please take a picture of your W2 from your employer.” Data collection agent 210 may communicate with the client in any form or combination of forms, including, but not limited to, written, auditory, or visual forms.

In addition (or alternatively) to data collection agent 210, tax system 200 may include question-and-answer agent 212. Question-and-answer agent 212 may be generally related to data collection agent 210 (such as how data collection agent 210 is described with regard to language model 310 depicted in FIG. 3). In some embodiments, question-and-answer agent 212 may be trained to explain tax outcomes, tax law, the tax return process, and other items to clients. For example, question-and-answer agent 212 may receive a question regarding a tax product and/or process from a client and provide an answer. Question-and-answer agent 212 may be trained to contextualize a client question to tailor the answer to the tax scenario of the client. In some embodiments, question-and-answer agent 212 may interface with tax professional questions plugin 214, where tax professional questions plugin 214 determines an answer to a question asked by the client. Tax professional questions plugin 214 may transmit the question to a human tax professional, such as tax professional 230, for answering. For example, tax professional questions plugin 214 may store the question using data persistence plugin 234 for later retrieval by tax professional 230 for answering.

Upon receiving information from a client, document manager agent 216 ingests the information into tax system 200. Document manager agent 216 receives information and interfaces with document processor plugin 218 to ingest the information into tax system 200 such that the information may be used by inferencing agent 202. A multitude of document types may be ingestible by document manager agent 216, including, but not limited to, W-2 forms, interest income forms, mortgage interest forms, written text, and other forms of documents. In some embodiments, document manager agent 216 interfaces with one or more systems external to tax system 200 for parsing the information received from the client.

In other embodiments, document processor plugin 218 parses the information received from the client. Document processor plugin 218 may perform any number of parsing tasks to ingest the information into tax system 200, including, but not limited to, optical character recognition (OCR), tokenization, regular expressions, natural language processing (NLP), semantic parsing, named entity recognition (NER), syntactic parsing, context-free grammars, finite-state automata, and sentiment analysis. In some embodiments, document processor plugin 218 parses the information received from the client and inputs the information into one or more tax data fields. For example, if the information received from the client includes wages, document processor plugin 218 may input the wages into the appropriate tax field for the individual tax return form (e.g., the 1040 Form).

Tax system 200 may include multiple components performing distinct tasks (e.g., processes) in order to complete a tax return. Said tasks may result in greater computational efficiency when completed in a specific order. Additionally, tax system 200 may receive prompts from a client beyond the scope of tasks the components within tax system 200 are designed to complete. As such, in some embodiments, tax system 200 may include orchestration agent 220 for orchestrating one or more agents within tax system 200 or outside of tax system 200. Orchestration agent 220 may do so by determining transitions to one or more available agents based on the workflow and/or a query of the user and interfacing with transitions plugin 222 to initiate the transitions. For example, orchestration agent 220 may orchestrate the tasks of inferencing agent 202, data collection agent 210, document manager agent 216, and a general large data collection agent housed externally from tax system 200. Broadly, orchestration agent 220 may interface with transitions plugin 222 to dynamically orchestrate the task completion of specific agents to increase computational efficiency during a session.

In some embodiments, orchestration agent 220 instructs a first agent to complete its set of tasks first before a second agent starts its set of tasks. Put another way, orchestration agent 220 may conduct a workflow-initiated transition, where orchestration agent 220 interfaces with transitions plugin 222 to initiate a transition from a first agent to a second agent based on completion of a task by the first agent. For example, orchestration agent 220 may instruct inferencing agent 202 to complete all its tasks (such as generating inferences and confidence scores) before orchestration agent 220 instructs document manager agent 216 to complete its tasks (such as ingesting documents received from a client).

In some embodiments, orchestration agent 220 conducts a user-initiated transition. A user-initiated transition may occur when a specific query is received from a client. For example, a user-initiated transition may occur when the client prompts tax system 200 with a question. As such, in some embodiments, orchestration agent 220 may interrupt the current workflow-initiated transition sequence to instruct question-and-answer agent 212 to determine an answer to the question of the client. Upon question-and-answer agent 212 answering the client, orchestration agent 220 may orchestrate a return to the workflow-initiated transition sequence.

In some embodiments, orchestration agent 220 defines an ordering for which agents are to complete tasks and instructs the agents accordingly. For example, inferencing agent 202 may be instructed to complete its tasks before document manager agent 216 is instructed by orchestration agent 220 to complete its tasks. For another example, inferencing agent 202 may be instructed to evaluate the confidence score of an inference before data collection agent 210 is instructed to perform the action associated with the inference. This may result in fewer errors occurring in the completion of a tax return. Continuing the example from above, data collection agent 210 would be prevented from reaching out for information defined by an inference that inferencing agent 202 has yet to decide is accurate enough to warrant prompting the client.

Agents within tax system 200 may have predetermined scopes of tasks, where the agent may only complete tasks within the predetermined scope of tasks of the agent. As such, in some embodiments, an agent may transmit information indicative of a task exceeding the scope and objective of the agent to orchestration agent 220. For example, if inferencing agent 202 receives un-ingested information for ingesting, inferencing agent 202 may transmit a message to orchestration agent 220 indicating inferencing agent 202 received an ingestion task. Accordingly, orchestration agent 220 may reassign the ingestion task to an agent having said task within its scope, such as document manager agent 216.

In some embodiments, orchestration agent 220 interfaces with external agents 224 to complete tasks. For example, if data collection agent 210 receives a question about the weather (which may extend beyond the knowledge base of data collection agent 210), orchestration agent 220 may interface with external agents 224 to complete the task of determining the weather and/or presenting the weather to the client. Upon the task being completed by external agents 224, orchestration agent 220 may return to using agents within tax system 200. By utilizing external agents 224 for certain tasks, tax system 200 may be tailored to the specific task of constructing a tax return for a client, resulting in greater efficiency with regard to time and money.

Upon finishing a tax return, tax system 200 may interface with return submission agent 226 for submitting the tax return. Return submission agent 226 may utilize return submission plugin 228 to verify the accurate completion of the tax return by tax system 200. For example, upon finishing a tax return, return submission plugin 228 may transmit the completed tax return to tax professional 230, where tax professional 230 is a person knowledgeable in tax law, tax filing, and/or tax return completion. Accordingly, tax professional 230 may review and update the tax return and/or one or more documents/data points submitted by the client during the session. In other embodiments, return submission plugin 228 may be independent of tax professional 230 such that the tax return is filed without intervention from tax professional 230. In some embodiments, return submission plugin 228 utilizes workflow check 232 to verify the workflow utilized to complete the tax return. For example, workflow check 232 may verify that a predetermined ordering of tax return completion steps was implemented in the completion of the tax return.

FIG. 3 depicts an exemplary machine learning system in accordance with embodiments of the invention and generally referred to as machine learning system 300. Machine learning system 300 may train language model 310, generally relating to data collection agent 210 and/or question-and-answer agent 212 depicted in FIG. 2, to interview a client during the tax return construction process. Machine learning system 300 may train language model 310 to converse with the client, prompt the client for information, answer client questions, and perform other client correspondence tasks.

Learning module 302 is operable to train language model 310 using training data. In some embodiments, learning module 302 receives training data from training data store 304. The training data received from training data store 304 may include historical text conversations, tax law, complete tax returns, and other information related to tax law. For example, training data received from training data store 304 may include historical conversations between tax professionals and clients demonstrating the questions asked by clients and the answers given by tax professionals. For another example, training data received from training data store 304 may include questions researched by clients relating to taxes. In regard to emotional analysis, as discussed below, training data received from training data store 304 may include information on emotions associated with taxes, including examples of emotions exemplified through historical conversations between tax professionals and clients.

In some embodiments, learning module 302 is operable to train language model 310 to prompt a client and receive and comprehend a response to the prompt (and vice versa). Any number of communication forms may be used for language model 310 to communicate with the client, including, but not limited to, video, sound, and written language. For example, language model 310 may be trained to receive video input, image input, sound input, or written language input from a client and respond to the client using video, image, sound, or written language.

In some embodiments, language model 310 is trained to provide explanatory information to the client. For example, language model 310 may provide the client with an explanation of the tax scenario of the client, tax law explanations, and explanations of the tax consequences associated with the tax scenario of the client or theoretical tax scenarios. In some embodiments, language model 310 is trained to answer questions asked by the client. For example, if a client asks language model 310 what the difference is between a standard deduction and an itemized deduction, language model 310 may be trained to output an answer outlining the difference between the standard deduction and the itemized deduction. In some embodiments, language model 310 contextualizes the question and applies the tax scenario of the client to the answer. Continuing the example above, language model 310 may be trained to recommend the standard deduction or the itemized deduction when explaining the difference of the deduction types to the client.

As described above, tax information may evoke an emotional response in a client when prompted for the tax information. For example, if the client was recently divorced, asking about a change in marital status may evoke a negative emotion within the client. As such, in some embodiments, learning module 302 is operable to train language model 310 to detect the emotional state of the client. By detecting the emotional state of the client, language model 310 may tailor its response to the client to consider the emotions of the client. For example, if the client is experiencing a negative emotion, language model 310 may tailor responses to be empathetic and caring. For another example, if the client is experiencing a positive emotion, language model 310 may tailor responses to recognize and increase positive emotions. Any number of emotions can be detected, including, but not limited to, frustration, lack of comprehension, sadness, anger, happiness, focus, and any other emotion.

In some embodiments, language model 310 is trained by learning module 302 to tailor responses to a client based on the detected emotion of the client. Responses may be tailored in any number of ways. Language model 310 may be trained to update the word choice used in responding to the emotions of the client. For example, if language model 310 detects happiness when discussing a real estate acquisition, language model 310 may update the language of “new real estate property” to “brand new home.” Language model 310 may be trained to update the mode of communication based on the emotions of the client. For example, if language model 310 detects sadness from a client during a video conversation, language model 310 may switch the mode of communication to written text.

In some embodiments, the tailored responses by language model 310 in response to client emotions may be predefined, such as by a system administrator. In other embodiments, language model 310 may be trained to mirror the emotional state of the client. For example, if communications from the client express joy, language model 310 may express joy in responsive communications, such as through word choice or AI voice inflection. Conversely, if communications from the client express sorrow, language model 310 may express sorrow in responsive communications

Language model 310 may be trained by learning module 302 using any type of machine learning now known or later developed, including, but not limited to, supervised learning, unsupervised learning, reinforcement learning, natural language processing (NLP) techniques like tokenization, named entity recognition (NER), syntactic parsing, semantic parsing, large language models (LLMs), sentiment analysis, machine translation, text summarization, question answering, speech recognition, emotion recognition, transfer learning, deep learning, multi-task learning, zero-shot learning, and semi-supervised learning.

After being trained, language model 310 may receive client response 306 and generate a model response 308. Client response 306 may be received through any interfacing means, including, but not limited to, an interface, an API, a personal computer, a mobile device, an image recorder, and any other device. Upon generation of model response 308, model response 308 may then be presented to the client through interface 312. Interface 312 may be any device or system for interfacing with the client, including, but not limited to, a personal computer, a mobile device, a user interface, a microphone, a teleconferencing device, or any other interfacing device.

In some embodiments, upon receiving model response 308 through interface 312, the client may respond to model response 308. The client may input a natural language response, a document, or any other form of input. For example, if model response 308 prompts the client for their legal name, a client response to model response 308 may be a written sentence of the legal name of the client as well as a document with a photocopy of the state-issued ID of the client.

If a response from the client is received, learning module 302 may refine language model 310 with the response from the client. Language model 310 may be refined to better detect the emotions of the client. For example, if the response from the client indicates a rise in anger, learning module 302 may refine language model 310 to use softer language in response to the emotion of anger being detected. For another example, if a response from the client indicates that the client was feeling sad rather than frustrated, as learning module 302 detected, learning module 302 may use the client's response to tune the ability of language model 310 to distinguish between sadness and frustration.

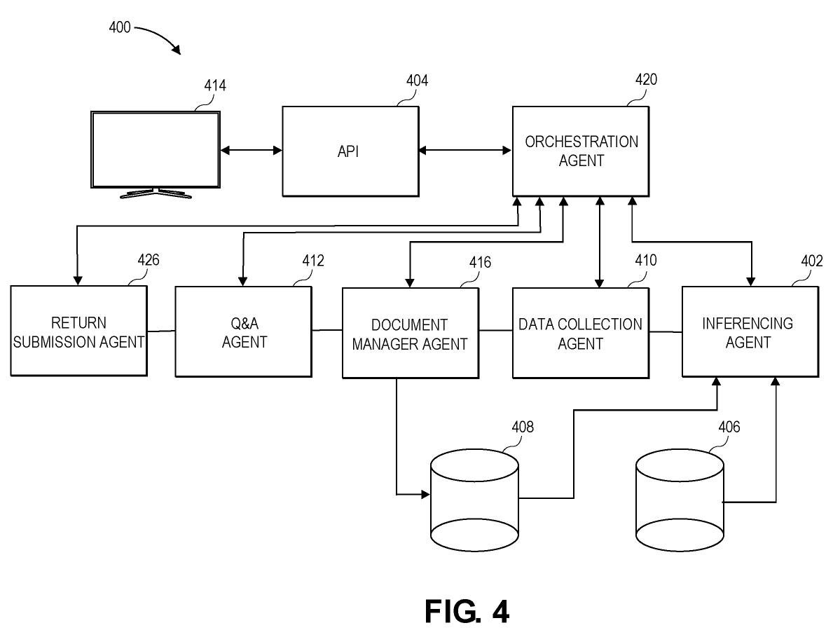

FIG. 4 depicts an exemplary tax assistance user flow in accordance with embodiments of the invention and generally referred to as client flow 400. Generally, client flow 400 is a flow representing the process of constructing a tax return for a client based on inferences. Client flow 400 may begin at the start of the session, the session starting when a request to complete a tax return is inputted into interface 414, generally related to interface 312 depicted in FIG. 3, and forwarded through API 404. API 404 may be a communication channel between a client and a system, such as tax system 200 depicted in FIG. 2. Additionally, an initialization may occur, where information related to

the client and/or the tax return completion process is retrieved and stored within tax system 200.

Information indicative of the start of a session may be received by orchestration agent 420 and provided to inferencing agent 402, generally related to inferencing agent 202 depicted in FIG. 2. Upon receiving the information indicative of the start of a session, inferencing agent 402 may obtain historical client data from historical data store 406, generally related to historical data store 206 depicted in FIG. 2. Upon obtaining the historical client data, inferencing agent 402 may analyze the data and determine one or more inferences based on the data, where the one or more inferences relate to the tax scenario of the client, one or more tax data fields, and any other pieces of information.

Upon making inferences regarding the tax scenario of the client, inferencing agent 402 may generate an inference on what additional information is needed from the client to complete the tax return. Through the inference, inferencing agent 402 may determine elements not yet present in the historical data that may require additional documents or information. For example, while historical data may not indicate the client investing in the past, inferencing agent 402 may make an inference that the client may have investment documents based on a perceived increase in salary of the client within the last two years.

In some embodiments, inferencing agent 402 may generate confidence scores for each inference made. The confidence scores may then be compared to a predetermined threshold, where, for example, inferences with confidence scores above the threshold are implemented, and inferences with confidence scores below the

threshold are not implemented. Upon determining which confidence scores exceed the predetermined threshold, one or more actions may be taken. For example, if a confidence score for the value of a tax data field exceeds a predetermined threshold, the tax data field of an individual tax return associated with the client may be filled out with the value.

In some embodiments, if an inference for additional information needed from the client exceeds the predetermined threshold, inferencing agent 402 may interface with data collection agent 410 to acquire the additional information from the client. As such, data collection agent 410, generally related to data collection agent 210 depicted in FIG. 2 and language model 310 depicted in FIG. 3, may prompt the client through API 404 for the additional information. The prompt to the client may be presented to the client through interface 414, such as through audio, text, video, or an image. Additionally, if the client inputs a query, orchestration agent 220 may instruct question-and-answer agent 412, generally related to question-and-answer agent 212 depicted in FIG. 2, to answer the question before returning to the workflow.

The client may then provide the requested information through interface 414, the additional information then being transmitted through API 404 to document manager agent 416, generally related to document manager agent 216 depicted in FIG. 2. In some embodiments, document manager agent 416 may parse the additional information and ingest the parsed information into session data store 408, generally related to session data store 208, as depicted in FIG. 2. In other embodiments, document manager agent 416 may interface with external systems to conduct the parsing such that the parsed information can be ingested into session data store 408.

Upon the additional information being ingested into session data store 408, inferencing agent 402 may then access session data store 408 and historical data store 406. Inferencing agent 402 may then utilize session data received from session data store 408 and historical data received from historical data store 406 to generate new inferences with new confidence scores, update existing inferences, or update existing inference scores. As such, inferencing agent 402 may then proceed with evaluating the confidence score of the inferences and implementing the tasks associated with the inferences accordingly. Client flow 400 may continue until a complete tax return is constructed. For example, inferencing agent 402 may provide information indicative of a complete tax return to any and all components of the system. Upon completion of the tax return, return submission agent 426, generally related to return submission agent 226, may submit the tax return for review by a tax professional and/or for filing.

Orchestration agent 420, generally related to orchestration agent 220 depicted in FIG. 2, may orchestrate any number of the tasks associated with client flow 400. For example, orchestration agent 420 may instruct inferencing agent 402 to begin analyzing historical data from historical data store 406 upon orchestration agent 420 receiving an indication of the start of the session from data collection agent 410. Additionally, as described above, orchestration agent 420 may interface with external agents to complete tasks outside of the scope of the components depicted in client flow 400. For example, if a client prompts through interface 414 for IRS documents, orchestration agent 420 may instruct an external agent to retrieve the IRS documents. For another example, orchestration agent 420 may instruct external retrieval agents to gather information for storage in historical data store 406 and session data store 408.

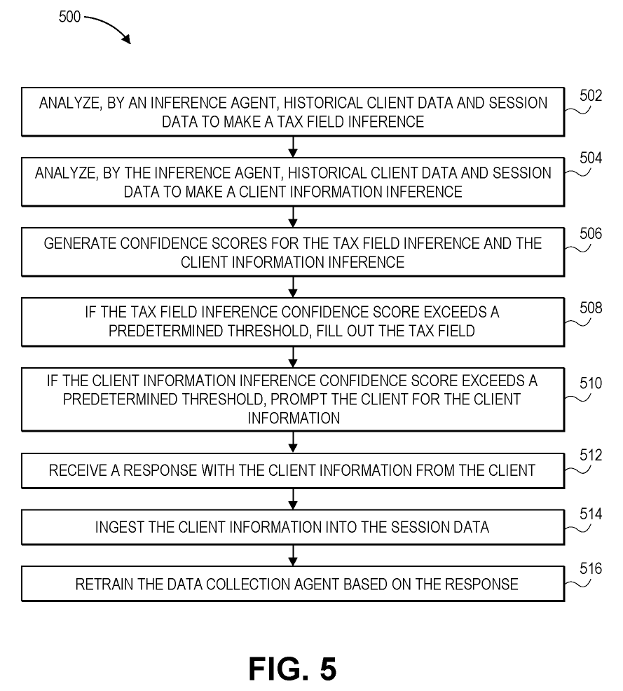

FIG. 5 depicts an exemplary flowchart for illustrating the operation of a method in accordance with embodiments of the invention and generally referred to as method 500. Generally, method 500 is a method for constructing a tax return using inferences. Method 500 may seek to minimize the number of prompts to the client for information. For example, method 500 may make inferences as to the information needed from the client so as to ask for all needed information at one time rather than prompting the client multiple times for information.

In step 502, historical client data and session data are analyzed to make a tax data inference. A tax data inference may correspond to the value of at least one tax field across one or more documents. For example, if the historical client data and session data give indications of the amount of wages for a client for the current tax year, the system may make an inference as to the value of the wages field on an individual tax return. In some embodiments, the inference made by the system, such as by an inferencing agent described above with regard to inferencing agent 202, may be a judgment of a tax field value.

In step 504, historical user data and session data are analyzed to make a client information inference. As described above, an inferencing agent may make an inference as to the tax scenario of the client. Accordingly, the inferencing agent may make an inference as to what information will be needed from the client in order to complete the tax return of the client and, therefore, complete a tax return for the client. As such, in some embodiments, the historical user data as well as session data may be analyzed to generate an inference regarding the information to request from the client. For example,

the system may make an inference that a proof of real estate sale document is needed from the client.

In step 506, confidence scores are generated for the tax data inference and the client information inference. As described above, a confidence score may correspond to the level of certainty the system has in the accuracy of the inference. The confidence score may be represented in a multitude of forms, such as a value out of x, where x represents absolute certainty, a percentage, a decimal, a binary value, a letter, or any other form. For example, a confidence score of 50 out of 100 may indicate the system is only 50% sure that the inference is correct.

In step 508, if the tax data inference confidence score exceeds a predetermined threshold, the tax field is filled out. By generating a confidence score for inferences, the system may ensure actions are only being taken in response to inferences having a predetermined amount of certainty, thus controlling the risk of action based on inferences. As such, in some embodiments, inferences are compared to a predetermined threshold. For example, the predetermined threshold may be 75% such that inferences with a confidence score below 75% are not implemented, while inferences with a confidence score of 75% or exceeding 75% are implemented. For example, if the tax data inference confidence score exceeds a predetermined threshold, the tax field may be filled out. For example, if the tax data confidence score for AGI is above the predetermined threshold, the AGI value of the tax return may be recorded as the value of the tax data inference.

In step 510, if the client information inference confidence score exceeds a predetermined threshold, the client is prompted for the client information. As described

above with regard to data collection agent 410 depicted in FIG. 4, a data collection agent may be used to prompt the client for client information. For example, a data collection agent may be used to ask the client questions where the response may elicit the information needed. For another example, a data collection agent may be used to ask the client for documents, where the documents include the needed information. In some embodiments, the client is prompted for the information in a natural language, such as English.

In step 512, a response is received from the client with the client information. In some embodiments, the response includes additional data points beyond the client information. For example, as explored further below, the response may include data points regarding the tone of voice of the client, the words used by the client, and other information that may indicate the emotional state of the client. In some embodiments, the client's response includes additional tax and/or personal information associated with the client that may be stored and used for later inferences.

In step 514, the client information is ingested into the session data store such that the client information becomes part of the session data. As described above with regard to FIG. 2, a document manager agent may be used to parse the information for ingesting, or the document manager agent may be used to interface with external systems for parsing the information for ingesting. The information ingested may be in the form of a document, such as a Word document or a PDF document, or the ingested information may be plain text, spoken word, video, or any other form. Any parsing technique may be used for ingesting the client information, including, but not limited to, OCR.

In step 516, the data collection agent is retrained based on the response. As described above with regard to FIG. 3, the response from the client may be used to refine the data collection agent communicating with the client to better detect and respond to the emotions of the client. For example, the data collection agent may be retrained to more accurately distinguish between a plurality of emotions, mirror the emotional state of the client, and respond to the client in such a way as not to evoke negative emotions from the client. Upon retraining the data collection agent, method 500 may proceed back to step 502 until the tax return of the client is completed.

Although the present disclosure has been described with reference to the embodiments illustrated in the attached drawing figures, it is noted that equivalents may be employed and substitutions made herein without departing from the scope of the present disclosure as recited in the claims.

Having thus described various embodiments of the present disclosure, what is claimed as new and desired to be protected by Letters Patent includes the following:

1. One or more non-transitory computer-readable media storing computer-executable instructions that, when executed by at least one processor, perform a method for constructing a tax return during a session, the method comprising:
generating, using a machine learning model trained to evaluate historical user data and session data based on a set of tax rules, a first inference indicative of user data to gather from a user associated with the session, the first inference based on the historical user data and the session data;
if a first confidence score of the first inference exceeds a first predetermined threshold, prompting the user for the user data;
parsing, using a parsing technique, the user data, wherein the user data is parsed from a response received from the user;
determining a second inference of a tax data value based at least one of the user data, the historical user data, or the session data; and
if a second confidence score of the second inference exceeds a second predetermined threshold, populating a tax field of the tax return associated with the tax data value of the second inference.

2. The one or more non-transitory computer-readable media of claim 1,
wherein prompting the user comprises:
generating a natural language query associated with the user data.

3. The one or more non-transitory computer-readable media of claim 2,
wherein the response is a natural language response to the natural language query.

4. The one or more non-transitory computer-readable media of claim 3,
wherein the method further comprises:
in response to receiving the natural language response, performing an emotional analysis on the natural language response to determine an emotional sentiment associated with the natural language response.

5. The one or more non-transitory computer-readable media of claim 4,
wherein the method further comprises:
generating, using the emotional sentiment, a second natural language query such that the second natural language query mirrors the emotional sentiment,
wherein the natural language query is a first natural language query.

6. The one or more non-transitory computer-readable media of claim 1,
wherein the user data is parsed from one or more documents received from the user in response to prompting the user,
wherein the response comprises the one or more documents.

7. The one or more non-transitory computer-readable media of claim 1,
wherein the parsing technique comprises performing natural language processing on auditory input, wherein the response is received as an audio file.

8. A method for constructing a tax return during a session, the method comprising:
generating, using a machine learning model trained to evaluate historical user data and session data based on a set of tax rules, a first inference indicative of a document to gather from a user associated with the session, the first inference based on the historical user data and the session data;
if a first confidence score of the first inference exceeds a first predetermined threshold, prompting the user for the document;
parsing, using one or more parsing techniques, the document, such that user data is obtained;
determining a second inference of a tax data value based on at least one of the user data, the historical user data, or the session data; and
if a second confidence score of the second inference exceeds a second predetermined threshold, populating a tax field of the tax return associated with the tax data value of the second inference.

9. The method of claim 8, the method further comprising:
verifying, utilizing the user data, that a second tax data value of a second tax field of the tax return is correct,
wherein the tax field is a first tax field, and the tax data value is a first tax data value.

10. The method of claim 8,
wherein the historical user data includes tax filing information from a previous year, including a filing status of the user.

11. The method of claim 8,
wherein the session data comprises data obtained from one or more third parties;
wherein the method further comprises:
obtaining, from a third party, the session data, wherein obtaining the session data is initiated by initialization of the session of the tax return.

12. The method of claim 11,
wherein the session data obtained from the third party includes a real estate transaction record.

13. The method of claim 8, further comprising:
refining, based on the document received, the machine learning model, such that one or more algorithms of the machine learning model are modified.

14. The method of claim 8,
wherein the machine learning model is trained on a set of previous tax returns of the user.

15. A system for constructing a tax return during a session, the system comprising:
an inferencing agent operable to generate one or more inferences based on historical user data and session data;
a data collection agent operable to generate and transmit one or more natural language prompts to a user associated with the session, the one or more natural language prompts comprising at least one request for a document; and
one or more non-transitory computer-readable media storing computer-executable instructions that, when executed by at least one processor, perform a method for constructing the tax return during the session, the method comprising:
generating, by the inferencing agent using a machine learning model trained to evaluate the historical user data and the session data based on a set of tax rules, a first inference indicative of the document to request from the user, the first inference based on the historical user data and the session data;
if a first confidence score of the first inference exceeds a first predetermined threshold, generating, by the data collection agent, a natural language prompt, wherein the natural language prompt includes the at least one request for the document;
parsing, using one or more parsing techniques, the document, such that user data is obtained;
determining, by the inferencing agent, a second inference of a tax data value based on at least one of the user data, the historical user data, or the session data; and
if a second confidence score of the second inference exceeds a second predetermined threshold, populating a tax field of the tax return associated with the tax data value of the second inference.

16. The system of claim 15,
wherein the data collection agent is a large language model trained to minimize a number of natural language prompts presented to the user to collect the user data.

17. The system of claim 15, further comprising:
a document manager agent operable to parse the document received by the data collection agent,
wherein the document manager agent is further operable to input one or more data fields parsed from the document into one or more tax fields of the tax return.

18. The system of claim 15, further comprising:
an orchestration agent operable to synchronize one or more tasks of the inferencing agent and the data collection agent.

19. The system of claim 15, further comprising:
an orchestration agent operable to suspend one or more tasks being performed by at least one of the inferencing agent of the data collection agent,
wherein the orchestration agent is operable to suspend the one or more tasks upon receiving a prompt from the user.

20. The system of claim 19,
wherein the orchestration agent is operable to unsuspend the one or more tasks upon transmittal of a response to the prompt to the user.
